(19) United States
(12) Patent Application Publication
(10) Pub. No.: US 2013/0330047 A1
(43) Pub. Date: Dec. 12, 2013

(54) OPTICAL CONNECTOR WITH BENT LIGHT PATH

(71) Applicant: I-THUN LIN, Tu-Cheng (TW)

(72) Inventor: I-THUN LIN, Tu-Cheng (TW)

(73) Assignee: HON HAI PRECISION INDUSTRY CO., LTD., Tu-Cheng (TW)

(21) Appl. No.: 13/594,845

(22) Filed: Aug. 26, 2012

(30) Foreign Application Priority Data
Jun. 12, 2012 (TW) 101120957

(51) Int. Cl. G02B 6/42

(52) U.S. Cl. 385/88

(57) ABSTRACT

An optical connector includes a printed circuit board (PCB), a photoelectric conversion module including a photoelectric conversion chip electrically connected to the PCB. An optical fiber positioned above and substantially parallel with the PCB, and a path bending module including a light pipe, which is substantially a quarter-circle arc in shape and positioned to connect the photoelectric conversion chip and the optical fiber. The light pipe includes a core having two ends facing the photoelectric conversion chip and the optical fiber, respectively, and a cladding surrounding the core. A refractive index of the core is higher than that of the cladding.

### BACKGROUND

1. Technical Field

The present disclosure relates to optical connectors and particularly to an optical connector which has a bent light path.

2. Description of Related Art

Optical connectors typically include a photoelectric conversion chip, such as a laser diode or a photo diode, and an optical fiber. The photoelectric conversion chip emits or receives light carrying data to or from the optical fiber for data transmission. In certain circumstances, it may be required to bend a light path between the photoelectric conversion chip and the optical fiber about 90 degrees to reduce a length or height of the optical connector. This may be achieved by a reflective mirror titled at 45 degrees with respect to the photoelectric conversion chip and the optical fiber. However, it is difficult to accurately position the reflective mirror to align the reflective mirror with the photoelectric conversion chip and the optical fiber.

Therefore, it is desirable to provide an optical connector, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of an optical connector, according to an embodiment.

FIG. 2 is a cross-sectional schematic view of the optical connector taken along a line II-II of FIG. 1.

### DETAILED DESCRIPTION

Embodiments of the present disclosure will now be described in detail with reference to the drawing.

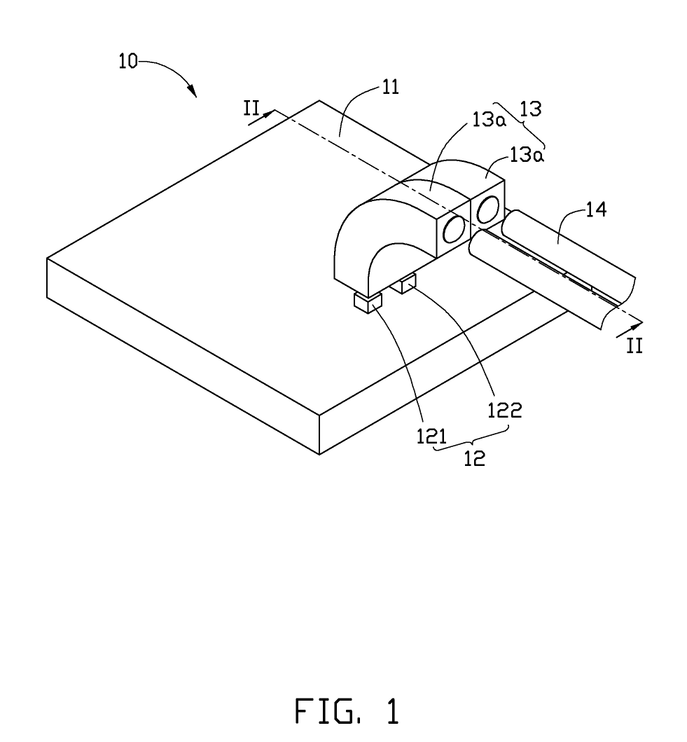

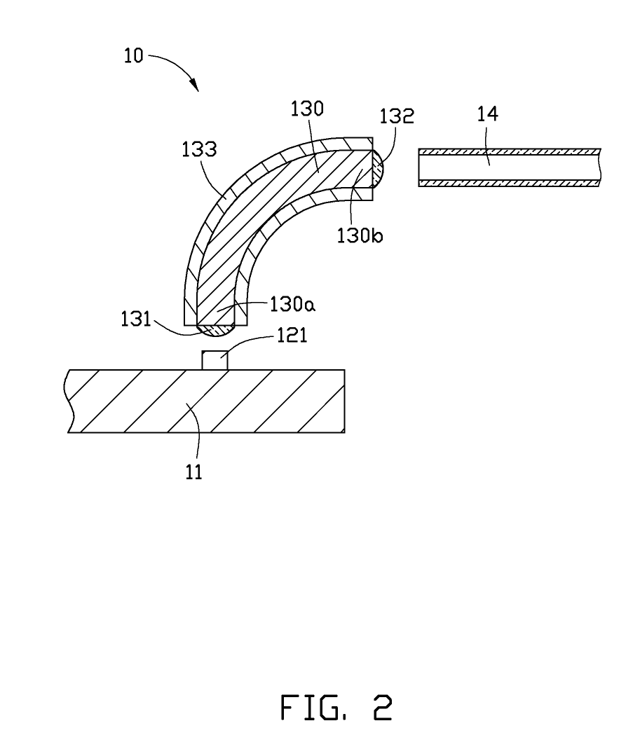

Referring to FIGS. 1-2, an optical connector 10, according to an embodiment is shown. The optical connector 10 includes a printed circuit board (PCB) 11, a photoelectric conversion module 12, a path bending module 13, and two optical fibers 14.

The photoelectric conversion module 12 includes two photoelectric conversion chips, such as a laser diode 121 and a photo diode 122, which are positioned on and electrically connected to the PCB 11. The PCB 11 forms various circuits (not shown) that connect with the photo electric conversion module 12 and thus can drive the laser diode 121 to emit light according to input data for transmitting the input data and can demodulate received data from light received by the photo diode 122.

The optical fibers 14 are positioned above and substantially parallel with the PCB 11, and correspond to the photoelectric conversion chips, respectively.

The path bending module 13 includes two light pipes 13a. Each of the light pipe 13a is substantially a quarter-circle arc in shape and positioned to connect the corresponding photoelectric conversion chip and the corresponding optical fiber 14. Each of the light pipes 13a includes a core 130 having two ends 130a, 130b, two lenses 131, 132 formed at the two ends 130a, 130b, respectively, and a cladding 133 surrounding the core 130. The lens 131 faces and focuses on the corresponding photoelectric conversion chip, while the lens 132 faces and focuses on the corresponding fiber 140. As such, light from the corresponding photoelectric conversion chip or the corresponding optical fiber 140 can be all directed into the core 130 by the lenses 131, 132, or light from the core 130 can be directed into the corresponding photoelectric conversion chip or the corresponding optical fiber 140 by the lenses 131, 132. A refractive index of the core 130 is higher than that of the cladding 133 to ensure light entering the core 130 is directed from one end to the other end of the core 130 by multiple total-reflections on an interface between the core 130 and the cladding 133.

In other embodiments, the lenses 131, 132 can be omitted if light intensity is greater enough for data transmission.

In other embodiments, the numbers of the photoelectric conversion chips and the light pipes can be changed depending on need.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. An optical connector, comprising:
a printed circuit board (PCB);
a photoelectric conversion module comprising a photoelectric conversion chip positioned on and electrically connected to the PCB;
an optical fiber positioned above and substantially parallel with the PCB; and
a path bending module comprising a light pipe, which is substantially a quarter-circle arc in shape and positioned to connect the photoelectric conversion chip and the optical fiber, the light pipe comprising a core having two ends and a cladding surrounding the core, the two ends of the core facing the photoelectric conversion chip and the optical fiber, respectively, and a refractive index of the core is higher than a refractive index of the cladding.

2. The optical connector of claim 1, wherein the photoelectric conversion chip is a laser diode.

3. The optical connector of claim 2, wherein the PCB is configured to drive the laser diode to emit light according to input data for transmitting the input data.

4. The optical connector of claim 1, wherein the photoelectric conversion chip is a photo diode.

5. The optical connector of claim 4, wherein the PCB is configured to demodulate received data from light received by the photo diode.

6. The optical connector of claim 1, wherein the light pipe comprises two lenses positioned at the two ends, respectively, one of the lenses faces and focuses on the photoelectric conversion chip, while the other lens faces and focuses on the optical fiber.
